(19) United States
(12) Patent Application Publication
(10) Pub. No.: US 2010/0304053 A1
(43) Pub. Date: Dec. 2, 2010

(54) Film Element Having a Polymer Layer

(75) Inventors: Haymo Katschorek, Obermichelbach (DE); Ludwig Brehm, Adelsdorf (DE)

Correspondence Address: HOFFMANN & BARON, LLP, 6900 JERICHO TURNPIKE, SYOSSET, NY, 11791, US

(73) Assignee: LEONHARD KURZ STIFTUNG & CO. KG, Furth (DE)

(21) Appl. No.: 12/599,082

(22) PCT Filed: May 7, 2008
(86) PCT No.: PCT/EP2008/003694

§ 371 Date: Jan. 4, 2010

(30) Foreign Application Priority Data
May 9, 2007 (DE) 102007022264.7-45

(51) Int. Cl. B32B 27/00

(52) U.S. Cl. 428/29

(57) ABSTRACT

The invention concerns a film element (20), in particular an embossing film, a laminating film or a sticker film, and a security document (1) having such a film element. The film element (20) has a first polymer layer comprising an at least partially oriented liquid crystal material, wherein the first polymer layer has one or more first regions which form a first security feature (41, 42) and in which the polymer layer in a case a) has linearly polarising or polarisation direction-rotating properties or in a case b) has circularly polarising properties. The film element further has a third polymer layer comprising an at least partially oriented liquid crystal material, wherein the third polymer layer has one or more third regions which form a second security feature and in which the polymer layer in the case a) has linearly polarising or polarisation direction-rotating properties or in the case b) circularly polarising properties. The film element further has a second polymer layer which is arranged between the first and third polymer layers and which in the regions arranged beneath the first regions and in the regions arranged above the third regions in the case a) has circularly polarising properties and in the case b) has linearly polarising or polarisation direction-rotating properties.

The invention concerns a film element, in particular an embossing film, a laminating film or a sticker film or a part of such a film which has a polymer layer comprising an at least partially oriented liquid crystal material.

EP 1 227 347 describes aligning liquid crystal polymers (LCP) on a photopolymer layer and in that way generating a security feature which can be detected by means of a polariser. A first orientation layer comprising a photopolymer is applied by printing to a substrate, which first orientation layer can be aligned in a given orientation direction by irradiation with polarised light. That layer is irradiated with polarised light. Then a layer comprising a liquid crystal material is applied to the orientation layer and conditions are produced, under which the liquid crystal material is aligned to correspond to the orientation of the photopolymer layer. The liquid crystal layer is then hardened by means of UV radiation. That provides an anisotropic polymer layer comprising an oriented liquid crystal material, whereby the light incident in that region is linearly polarised.

In addition EP 1 227 347 describes that two orientation layers can be applied to a substrate in mutually superposed relationship. In that case the two layers are respectively irradiated with differently polarised light and then fixed so that this provides orientation layers involving a differing orientation, arranged in mutually superposed relationship. That multiple coating procedure in combination with a suitable patterned configuration of the individual, mutually superposed photopolymer layers thus makes it possible to achieve regions involving a differing orientation of the photopolymer layers and the liquid crystal layers, in which the light is linearly polarised in different directions.

Furthermore WO 01/55960 describes the provision in a security element of a layer comprising a liquid crystal material which is aligned region-wise in various orientation directions. In this case also orientation of the liquid crystal molecules is effected by means of a photopolymer layer which is exposed with linearly polarised light and subsequently serves for orientation of the liquid crystal molecules prior to crosslinking thereof. In that case regions involving a different alignment of the liquid crystal molecules are so arranged that an object is encoded in those regions, which is decodable by means of a special associated polariser which also has a suitable liquid crystal layer which is matched to the security element and which is oriented differently in region-wise manner. In that way it is possible to introduce two different items of image information into an optical security element: when viewing the security element through a ‘normal’ polariser a first latent image is displayed. When the security element is viewed through the above-described polariser which is matched to the security element, with a liquid crystal layer oriented differently in region-wise manner—hereinafter referred to as the ‘key’—a second latent image is decoded and thus rendered visible. A disadvantage with this method is that the security element and the ‘key’ (analyser tool) must be exactly matched to each other and the additional security element can be rendered visible only when there is a suitable ‘key’. The production of an appropriate ‘key’ is thus linked to a similarly high level of complication and expenditure to the production of the actual security element.

Now the object of the invention is to provide an improved optical security element which is based on oriented liquid crystal layers and which combines two selectively readable latent items of image information which can be rendered selectively visible with commercially available and inexpensive analyser tools.

That object is attained by a film element, in particular an embossing film, a laminating film or a sticker film having a top side and an underside, which—in mutually superposed relationship—has a first, a second and a third polymer layer comprising an at least partially oriented liquid crystal material. In this case the first polymer layer has one or more first regions which form a first security feature and in which the polymer layer has linearly polarising or polarisation direction-rotating properties. The third polymer layer has one or more third regions which form a second security feature and in which the polymer layer has linearly polarising or polarisation direction-rotating properties and the second polymer layer arranged between the first and third polymer layers has circularly polarising properties in the regions arranged beneath the first regions and in the regions arranged above the third regions. An inverse structure is also possible in which the first polymer layer has one or more first regions which form a first security feature and in which the polymer layer has circularly polarising properties, the third polymer layer has one or more third regions which form a second security feature and in which the polymer layer has circularly polarising properties and the second polymer layer arranged between the first and third polymer layers has linearly polarising or polarisation direction-rotating properties in the regions arranged beneath the first regions and in the regions arranged above the third regions.

It was surprisingly found that, with such a structure of a film element, when viewing through a polariser or by means of polarised light, the first or the second security feature can be rendered visible to the human viewer selectively in dependence on the viewing direction. If thus the top side of the film element is viewed in the transillumination mode through a polariser between the film element and the human viewer, the first security element thus becomes visible, for example a figurative representation which changes upon rotation of the polariser. If the rear side of the film element is viewed in the transillumination mode through a polariser between the film element and the human viewer, the second security element becomes selectively visible. If the rear side of the film element is irradiated with polarised light and the film element is viewed in the transillumination mode from the front side, the second security feature is selectively rendered visible and in the reverse case, that is to say when viewing from the rear side and when the light source is arranged at the front side, the first security element is selectively rendered visible. A corresponding effect which is dependent on the viewing direction is also afforded when viewing in the incident light mode. The film element according to the invention thus presents an easily remembered optical effect which is surprising to the viewer and in a simple fashion, by means of a single simple analyser tool, makes it possible selectively to render two different items of information visible in one and the same region. Thus two different items of information are selectively rendered visible for example in dependence on the viewing side (front side or rear side). By virtue of the complex co-operation of three different polarisation layers which comprise partially oriented liquid crystal materials and which encode different items of information and which have different polarising properties, and the arrangement of integrating those layers in the film element in mutually superposed, mutually precisely aligned relationship, the security feature which is afforded by the invention can only be imitated with very great difficulty. The film element thus affords a high level of security, linked to the above-mentioned disadvantage that simple, inexpensive and wide-spread aids can be used for selectively decoding two different concealed security features.

Advantageous configurations of the invention are recited in the appendant claims.

In accordance with a preferred embodiment of the invention the film element is in the form of a transparent film element for the human viewer when viewing in the transillumination mode without a polariser or without polarised light, that is to say all layers of the film element are transparent under those viewing conditions. When viewing in the incident light mode or inclinedly in the transillumination mode, a color effect or upon tilting a color change effect can yes or no occur in dependence on the viewing angle, that being caused by the cholesteric liquid crystal materials used.

Generally the film element comprises three or more layers which appear transparent in the direct transillumination mode, the first, second and third polymer layers each forming a respective one of the transparent layers. In this respect, any layer is viewed as a transparent layer, which has an average transmission degree of more than 50% in the range of the unpolarised light which is visible to the human viewer. It is also possible in this case for one or more of the transparent layers to be colored or to have a color filter effect so that the film element affords a colored, translucent impression when viewed in the transillumination mode without an analyser tool or without polarised light. When viewing in the transillumination mode without a polariser the film element thus gives the human viewer when viewing from both sides the impression of a transparent region, through which objects or also printing applied to a substrate can be viewed. When viewing through a polariser or by means of polarised light, that transparent region then surprisingly displays different optical information, when viewing from different sides.

It is of particular advantage in this respect if the first and third regions of the first and third polymer layers respectively at least region-wise overlap so that in dependence on the viewing direction the first or the second security element becomes visible to the human viewer in one and the same region.

Preferably a cholesteric liquid crystal material is used for the polymer layers having circularly polarising properties. That liquid crystal material further has viewing angle-dependent color filter properties so that, particularly when viewing in the incident light mode, against a dark background, a viewing angle-dependent color shift effect appears to the human viewer in the region of the film element, as a further optically recognisable security feature.

The central second polymer layer is preferably formed by a cholesteric liquid crystal material having circularly polarising properties. That is applied over an area under the oriented regions of the first and third polymer layers.

A further possible configuration of that central second polymer layer provides that it is combined from two layers of different cholesteric liquid crystal materials with a differing color filter effect. In this case the polymer layer 2 is composed of a layer portion 2a with the one cholesteric liquid crystal material and a layer portion 2b with the other cholesteric liquid crystal material. If the layer portion 2a is towards the eye of the viewer when viewing in the incident light mode, the color change of the cholesteric liquid crystal material used for the layer portion 2a appears upon tilting (for example red-green). If the element is viewed at the rear side, that is to say the layer portion 2b is towards the eye of the viewer, the color change of the liquid crystal material used for the layer portion 2b appears (for example green-blue).

In addition it is also possible for the second polymer layer to be implemented by partial printing of two or more different cholesteric liquid crystal materials with different color effects. In that way further color change effects are to be achieved, for example partial red-green and partial green-blue color changes upon tilting.

It is further possible for the partial printing to be such that, by virtue of the differing coloration of the partially printed regions, a further item of image information which is permanently visible under suitable viewing conditions is produced (for example a green symbol on a red background which becomes a blue symbol on a green background upon tilting). With these variants, a first-line feature and thus a further added value can be added to the security element.

Preferably the first and/or third regions in which the first or third layer respectively has polarising properties forming the security feature represent subregions of the first and third liquid crystal layer respectively. In the other region, which is not associated with the first or third region respectively, of the first and second liquid crystal layer respectively, that liquid crystal layer does not have any polarising properties or polarisation properties which differ from the polarisation properties of the first or third regions respectively. Preferably therefore the first polymer layer is provided not only in the region of the one or more first regions, but also in one or more remaining regions which preferably surround the first regions, so that the region in which the first polymer layer is provided is composed of the one or more first regions and one or more remaining regions. In the one or more remaining regions the first polymer layer has no polarising properties or polarisation properties which differ from those of the first region, preferably in case a) linearly polarising or polarisation direction-rotating properties differing form the first regions and in case b) circularly polarising properties differing from the first region. A corresponding consideration preferably also applies to the third polymer layer.

Preferably the first polymer layer, the second polymer layer and the third polymer layer are provided over the full surface area in a region of the film element.

Preferably the first polymer layer includes one or more first zones in which the first polymer layer in case a) has linearly polarising or polarisation direction-rotating properties and in case b) circularly polarising properties, and one or more second zones in which the first polymer layer does not influence polarisation of the incident light or have polarising properties which differ from those of the first zones. Preferably in case a) the first polymer layer in the first zones does not have any polarising properties or linearly polarising or polarisation direction-rotating properties which differ from those of the first zones, and in case b) it does not have any polarising properties or circularly polarising properties differing from those of the first zones. Thus for example in case a) the angular position of the polarisation direction in the first and second zones differs and in case b) the handedness of circular polarisation differs in the first and second zones. In addition it is also possible for the first polymer layer to include one or more third zones or one or more fourth zones in which the first polymer layer has polarisation properties differing from those of the first and second zones or the first, second and third zones respectively. The one or more first regions forming a first security feature are preferably formed by the first zones. It is however also possible for one or more first regions forming the first security feature to be formed by two or more of the zones, selected from the group consisting of the first zone, the second zone, the third zone and the fourth zone, which respectively have in case a) linearly polarising or polarisation direction-rotating properties or in case b) circularly polarising properties. In that way it is possible to implement gray scale images as the first security feature, as is also described in further detail hereinafter.

The third polymer layer is preferably constructed as described above in relation to the first polymer layer. The third polymer layer thus preferably also includes first and second zones, wherein the first zones in case a) have linearly polarising or polarisation direction-rotating properties and in case b) circularly polarising properties and the second zones do not have any polarising properties or have polarising properties differing from the polarisation properties of the first zones. Besides the first and second zones the third polymer layer can also have one or more further zones in which the polarisation properties of the third polymer layer differ from those of the first and second zones so that gray scale images can also be encoded into the third polymer layer as the second security feature. The one or more regions forming the second security element are formed as described above by the first zones or by first and second, first and third, first and fourth, first, second and third or first, second, third and fourth zones, if those zones in case a) have linearly polarising or polarisation direction-rotating properties or in case b) circularly polarising properties. That makes it possible to generate gray scale images, as described below.

Thus the first polymer layer and/or the third polymer layer each respectively includes the above-specified first and second zones.

The differing polarisation properties of the first, second and third zones of the first and third polymer layers respectively are preferably achieved by suitably different region-wise properties of a first or third orientation layer respectively, to which the liquid crystal material of the first or third polymer layer respectively is applied and in accordance with which the liquid crystal material of the first and third polymer layers respectively is oriented. The first and the second orientation layers thus also have first zones and second zones which differ in respect of their orientation properties.

The first regions of the first polymer layer preferably have varying polymerisation properties. For example linearly polarising first regions have a different azimuth orientation of the polarisation axes, the polarisation direction-rotating first regions have a different rotary angle and differently circularly polarising first regions have oppositely circularly polarising properties (left-handedly/right-handedly circularly polarising). In that way it is possible to encode as the first security feature a representation of an object which changes upon rotation of the polariser/film element and under some circumstances changes to a different representation. In addition it is thus also possible to encode as the first security feature two objects in the first polymer layer, with which the first object is visible at a first relative angle between polariser/film element and the second object is visible at a second relative angle between film element and polariser. In that respect a first group of first regions is preferably associated with the first object and a second group of first regions with the second object. In addition it is also possible to encode a gray scale image of an object as a security feature in the film element by first regions which are different in that way.

The first regions with different linearly polarising or polarisation direction-rotating properties or different circularly polarising properties have a smallest extent of less than 300 μm so that an integral image is afforded for the human viewer at a normal viewing distance.

It is also possible for the third regions of the third polymer layer—as described above—to be provided with different linearly polarising and polarisation direction-rotating properties or different circularly polarising properties respectively and thus also to provide a particularly forgery-resistant and striking second security feature by the film element.

The film element preferably further has at least one transparent carrier layer, for example one or more polyester carriers of a layer thickness of between 5 μm and 50 μm. Thus it is possible for the film element to be disposed in the region of a transparent window of a security document and thus made accessible to viewing in the transillumination mode.

In a preferred embodiment of the invention the film element further has at least one replication layer on which the first or the third polymer layer comprising a liquid crystal material is applied. In the first and third regions a diffractive structure for orientation of the polymer layer of a liquid crystal material is introduced into the surface of the replication layer, that is towards the liquid crystal material polymer layer. The diffractive structure serves in that case for orientation of the anisotropic polymer material. By means of such a technology it is possible on the one hand for the anisotropic polymer layer of a liquid crystal material to be particularly precisely oriented by means of an inexpensive production procedure. Furthermore that provides a particularly effective possible way of producing a polymer layer which in different regions has different linearly polarising or polarisation direction-rotating properties or different circular polarising properties respectively. Those different properties are achieved for example by a different azimuth orientation of a linear grating used for orientation of the liquid crystal material, for example a linear grating having a spatial frequency of between 1500 lines/mm and 3500 lines/mm and of a depth of between 50 nm and 500 nm.

In accordance with a further preferred embodiment of the invention, besides the above-described layers, the film element has one or more further layers which provide a further optically recognisable security feature for the human viewer, preferably also in the first and third regions. As described hereinbefore that can be achieved on the one hand by a combination of different cholesteric liquid crystal materials in the polymer layer. In addition it is possible to provide one or more layers having an optically effective relief structure, for example a Kinegram® or a hologram, in the film element. For that purpose for example an optically effective relief structure is shaped into a replication lacquer layer and then coated with an HRI or LRI layer (HRI=high refraction index; LRI=low refraction index). In that respect the optically effective relief structures used can also be microlens structures, matt structures or refractively acting macrostructu res.

In addition it is also possible to provide as such a layer a thin film layer system for producing color shifts by means of interference or a layer having an optically variable material, for example a layer with a luminescent material, in the film element.

In that respect the film element is preferably part of a film, for example a laminating film, a transfer film or a sticker film, which is applied to a value-bearing document or a security document. As already mentioned hereinbefore the region of the film that forms the film element is preferably arranged in the region of a transparent window of the security document/value-bearing document. Besides the security features provided in the region of the film element—as described above—the film can also have further security features which apply as reflective security elements for example outside the transparent window of the security document. In a further embodiment it is also possible for the security element also to have a polariser which can be brought into overlapping relationship with the film element by folding or bending the security element and can thus be used by the user for verifying the first and second security features.

The invention is described by way of example hereinafter by means of a number of embodiments with reference to the accompanying drawing.

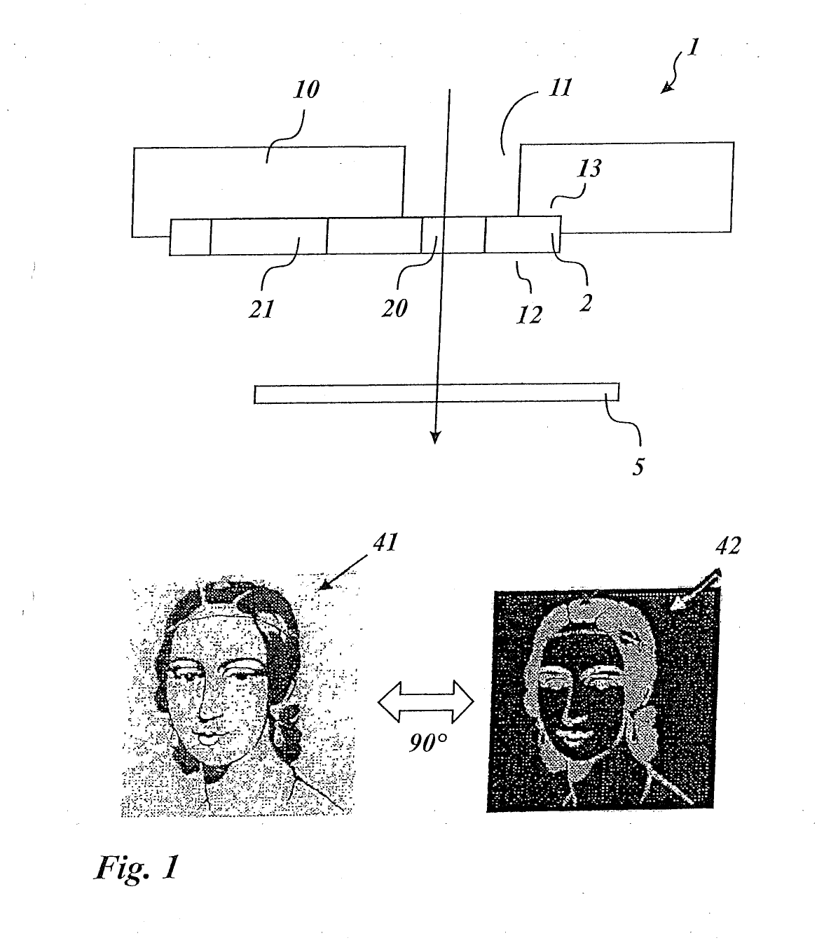

FIG. 1 shows a diagrammatic view of the representations afforded for a viewer in a first viewing direction of a film element according to the invention,

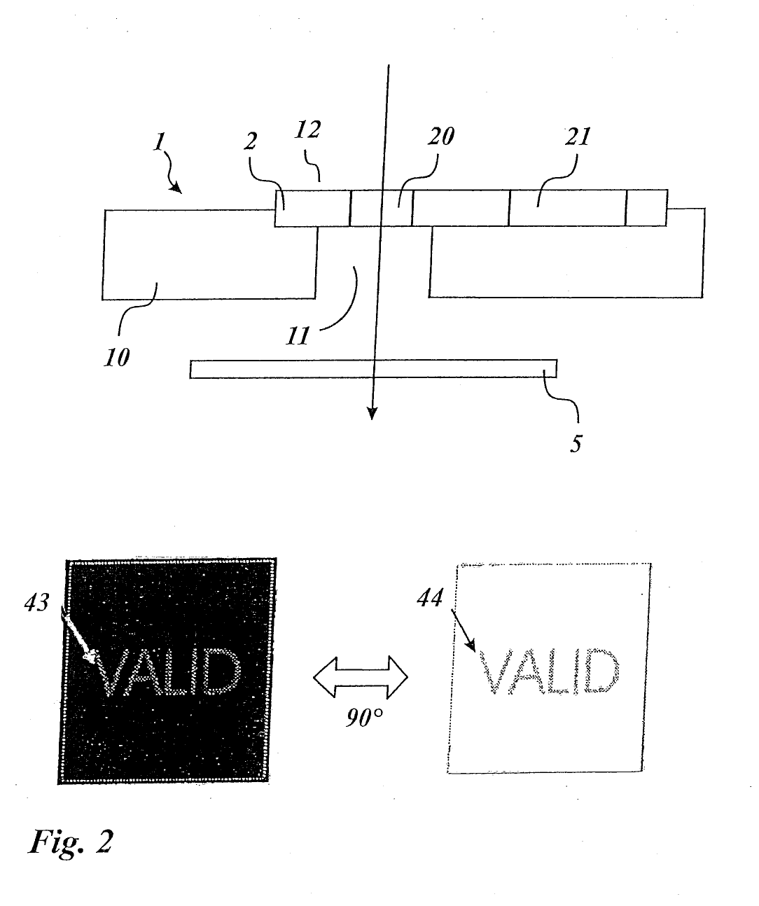

FIG. 2 shows a diagrammatic view of the representations afforded to the viewer of the film element according to the invention in a second viewing direction,

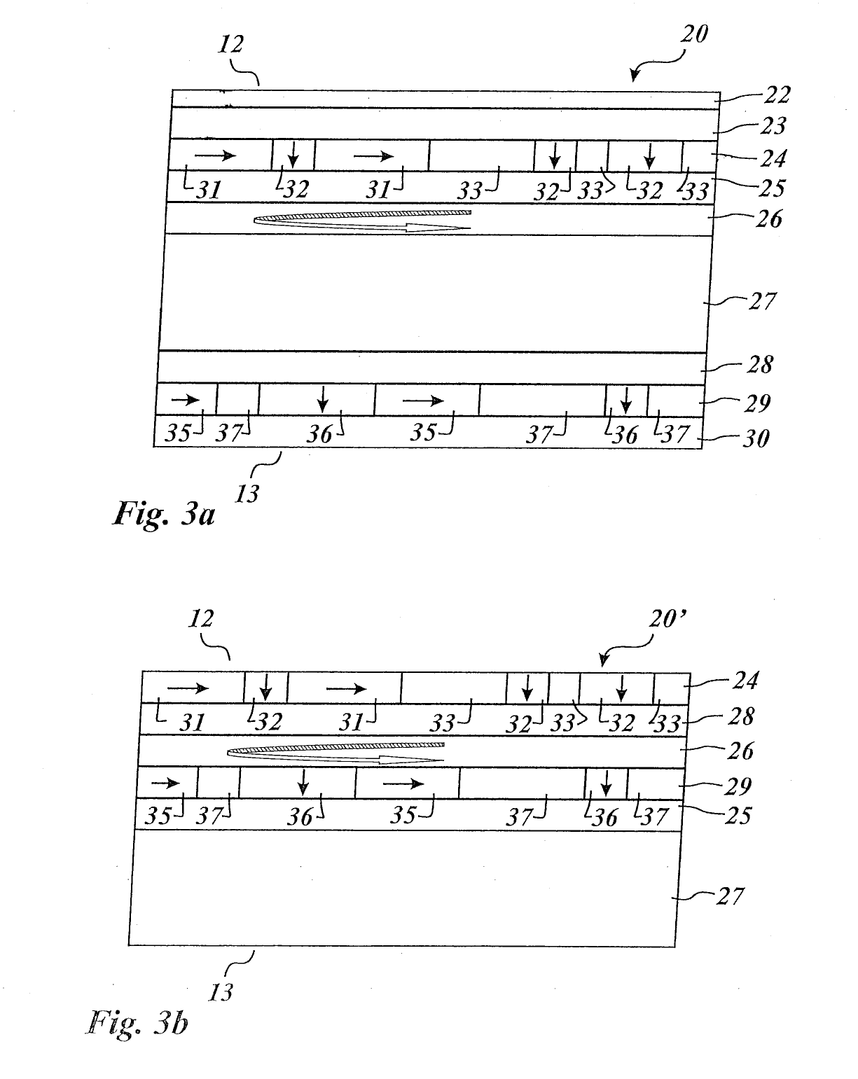

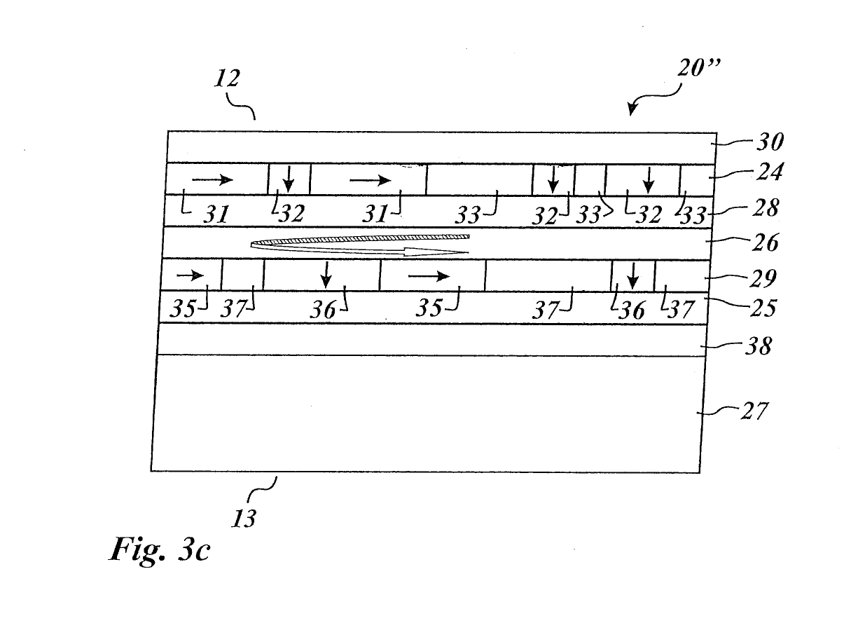

FIG. 3a shows a sectional view of the film element according to the invention for a first embodiment thereof,

FIG. 3b shows a sectional view of the film element according to the invention for a second embodiment thereof,

FIG. 3c shows a sectional view of the film element according to the invention for a further embodiment thereof,

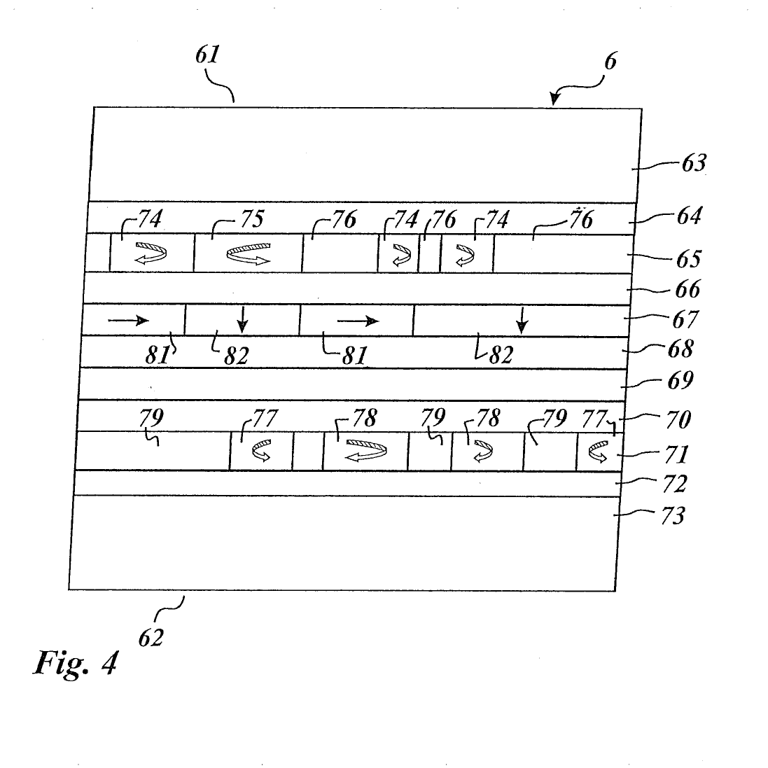

FIG. 4 shows a sectional view of the film element according to the invention for a further embodiment thereof, and

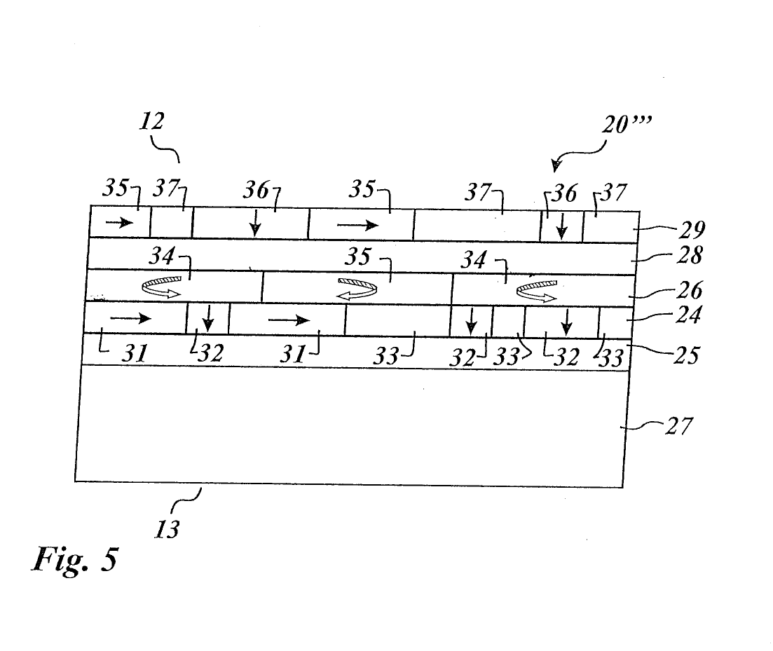

FIG. 5 shows a sectional view of the film element according to the invention for a further embodiment thereof.

FIG. 1 shows a security document 1, a polariser 5 and two representations 41 and 42.

The security document 1 is for example a banknote, an identity card or pass, a visa, a ticket or a software certificate. In this case the security document 1 has a carrier element 10 and a film 2 applied to or introduced into the carrier element 10. The carrier element 10 comprises for example paper, a plastic material or also a composite material of paper and plastic. It is also possible for the carrier element 10 to be provided on one or both sides with one or more printed security layers.

The security document 1 has a transparent window 11. In the region of the transparent window 11—as shown in FIG. 1—the carrier element 10 has an opening. It is however also possible for the carrier element to have transparent optical properties in the region of the transparent window 11. The film 2 is applied to the carrier element 10 preferably in the form of a security strip or as a security patch or also as a security thread. The film 2 is preferably applied in the form of a transfer layer portion of a hot embossing film to the carrier element 10. It is however also possible for the film 2 to be dispensed on to the carrier body 10. In that case the film 2 is applied to the carrier element 10 in such a way that the film 2 completely covers over the region of the transparent window 11 and a region of the film 2 is disposed with a film element 20 in overlapping relationship with the region of the transparent window 11.

The film 2 has a top side 12 and an underside 13 and includes one or more film elements providing security elements for checking the authenticity of the security document. Thus for example besides the film element 20 which—as shown in FIG. 1—is arranged in the region of the transparent window 11 the film 2 also has a further film element 21. The film elements 20 and 21 are respectively formed in that case by subregions of the film 2. It is however also possible for the film elements to be formed by a subset of the layers of a film in a given region of the film.

The structure of the film element 20 is shown by way of example in FIG. 3a. In this embodiment the imaging anisotropic polymer layers are disposed on both sides of a carrier material. An embodiment is also possible in which all anisotropic polymer layers are disposed on the same side of the carrier material. That structure is described with reference to FIGS. 3b and 3c and FIG. 5.

FIG. 3a shows the film element 20 with a top side 12 and an underside 13. The film element 20 has a protective lacquer layer 22, a layer 23, a polymer layer 24, a layer 25, a polymer layer 26, a carrier layer 27, a layer 28, a polymer layer 29 and an adhesion layer 30. The film element may—but does not have to—have the protective lacquer layers 22 and 23. The adhesion layer 30 represents a layer of adhesive with which the security element is fixed on the carrier element 10.

The polymer layers 24 and 29 are the imaging anisotropic polymer layers. The layers 25 and 28 are the orientation layers for the anisotropic polymer layers (for example replication layers, photopolymer layers, scuffed polymer layers etc). The polymer layer 26 is a further anisotropic polymer layer. This can also comprise two different layer portions of two different anisotropic polymers or may also include a plurality of regions of partially printed, different anisotropic polymers.

The protective lacquer layer 23 is preferably between 0.3 and 1.2 μm in thickness. The protective lacquer layer preferably comprises UV-crosslinkable acrylates or abrasion-resistant thermoplastic acrylates. It is also possible to dispense with the protective lacquer layer 22. In addition it is also possible to provide a transparent polyester carrier of a thickness of between 5 and 50 μm instead of the protective lacquer layer 22. If the layer 22 is a transparent carrier the layer 23 is formed depending on the security element production process either by an adhesive layer or an orientation layer for the anisotropic polymer layer 24. In the latter case it is then possible to dispense with the layer 25.

The orientation layers 25 (or 23) and 28 can be for example replication layers in which diffractive structures are impressed by means of an embossing tool. The replication layers in that case preferably comprise a transparent thermoplastic material applied to the protective lacquer layer 22 for example by a printing process.

As an alternative thereto the orientation layers can also comprise the same or different anisotropic polymers, structured as specified above or in another fashion. In a further embodiment the surface of the layer 26 can also be structured and serve directly as an orientation layer for the anisotropic polymer layer 24. In this embodiment it is then possible to dispense with the layer 25.

By way of example a configuration in the form of an element with two replication lacquer layers is described hereinafter, that is to say the orientation layers 25 and 28 are formed by replication lacquer layers. In this case the replication lacquer layers are for example of the following composition:

| Component | Parts by weight |
|---|---|
| High-molecular PMMA resin | 2000 |
| Silicone alkyd | 300 |
| Non-ionic wetting agent | 50 |
| Low-viscosity nitrocellulose | 750 |
| Methylethylketone | 12000 |
| Toluene | 2000 |
| Diacetone alcohol | 2500 |

The carrier layer 27 is a carrier film of a thickness of between 5 and 50 μm comprising a plastic material, for example a biaxially stretched polyester film or polyolefin film of that thickness.

The layer 26 is a polymer layer which has circularly polarising properties in the entire region of the film element 20. The layer 26 in the FIG. 3 embodiment is an oriented layer of cholesteric liquid crystal material. By way of example the cholesteric liquid crystal material used can be the cholesteric liquid crystal materials described in WO 01/55960. In this case the layer 26 is preferably of a thickness of between 0.2 and 10 μm. The liquid crystals of the layer 26 are oriented for example when spreading the polymer layer 26 on the carrier layer 27, by the shearing forces occurring then. It is also possible for a further micro-scuffed or brushed orientation layer to be provided or for the carrier layer 27 to be micro-scuffed or brushed prior to application of the polymer layer 26 to the surface that is towards the polymer layer 26, in order thereby to permit orientation of the cholesteric liquid crystals. In its configuration as a cholesteric liquid crystal layer the polymer layer 26 acts as a filter which in dependence on the angle of incidence of the incident light reflects a specific wavelength component of the incident light and transmits a specific wavelength component of the light so that a viewing angle-dependent color shift effect is to be observed (against a dark background which absorbs the transmitted light).

The replication lacquer layer 25 is applied to the layer 26 and the orientation layer is structured.

The replication lacquer layer is applied for example by means of a line raster intaglio printing roller with an application weight of 2.2 g/m² after drying, dried in a drying passage at a temperature of between 100 and 120° C. and then embossed with a diffractive structure with a heated embossing roller or a heated embossing punch at about 130° C. It is further possible instead of a thermoplastic replication lacquer to use a UV-hardenable replication lacquer and to shape the diffractive structures into the layer 25 by means of UV-replication.

In that respect a line grating with a large number of lines, for example with a resolution of between 1500 lines/mm and 3500 lines/mm, with a preferred depth of between 50 nm and 500 nm, is shaped in the regions of the security element, in which the polymer layer 24 is to have linearly polarising or polarisation direction-rotating properties.

It is further possible for the azimuth angles of the line gratings to differ region-wise, whereby different linearly polarising or polarisation direction-rotating properties can be achieved in the polymer layer 24.

A layer of an optically anisotropic polymer material, preferably a liquid crystal material (LC) is then applied to the structured orientation layer 25. In principle all liquid crystal materials referred to in the above-mentioned publications can be used for the layer 25. Preferably a nematic liquid crystal material from the OPALVA® series from Vantico AG, Basle, Switzerland is used. That liquid crystal material is applied to the replication layer 25 over the full surface area or partially, preferably by means of a printing process, preferably with an application weight which in the case of a flat surface affords a layer thickness of between 0.5 μm and 5 μm. The effective layer thickness of the anisotropic polymer layer 24, which is formed locally after application of the liquid crystal material, as well as the alignment of the liquid crystal molecules of the polymer layer 24 are influenced in that case by the diffractive structure embossed into the replication layer 25.

The liquid crystals of the anisotropic polymer layer 24 are then aligned if required with the application of heat. UV-hardening or thermally induced radical crosslinking of the liquid crystal material is then effected to fix the orientation of the liquid crystal molecules and the thickness of the anisotropic polymer layer 24.

In addition it is also possible for the printed layer of a solvent-bearing liquid crystal material to be subjected to a drying process and for the liquid crystal molecules to be oriented during evaporation of the solvent, in accordance with the diffractive structure. It is also possible for solvent-free liquid crystal material to be applied by a printing process, whereupon orientation is fixed by crosslinking.

It is also possible for the different orientation of the liquid crystal molecules of the polymer layer 24 to be effected by orientation of the liquid crystal layer at a differently exposed photopolymer layer or a layer provided with a surface relief by micro-scuffing.

In the regions 31 and 32 in which the above-described diffractive structure is shaped into the layer 23 the polymer layer 24 has linearly polarising properties, wherein the differing azimuth angle of the diffractive structure in the regions 31 and 32 means that the polymer layer 24 has differing linearly polarising properties in the regions 31 and 32. In the regions 33 in which the diffractive structure is not shaped into the layer 23 the polymer layer 24 does not have special properties of influencing the polymerisation of the incident light. In the FIG. 1 embodiment the azimuth angles of the diffractive structures in the regions 31 and 32 and thus the polarisation axes are rotated through 90° relative to each other. The regions 31 and 32 form image regions of an object representing a security feature, for example a representation of Clara Schumann. In this case each of the regions 31 and 32 is associated with an image pixel or an image region of the object, wherein depending on the respective gray scale value a region 31 or a region 32 is used for the respective pixel or image region.

It is also possible instead of two different kinds of differing linearly polarising or polarisation direction-rotating properties, to provide three or more different kinds of such regions, in which for example the azimuth angle or the polarisation axis differs in each case by 10°. A representation in the manner of a gray scale image can then be composed as the security feature from those different kinds of regions so that—as described hereinafter—when viewing in polarised light or through a polariser, depending on the respective angular position of the film element 20 relative to the polariser/the light source, a gray scale image of the object, which changes in its gray scale values, becomes visible to the viewer. It is also possible for the different kinds of regions to be associated with different objects and thus, depending on the respective angular position of the film element 20 relative to the polariser/the light source, different objects become visible as the security feature to the viewer. In that case preferably the individual regions—for example the regions 31 and 32—are selected to be so small that their smallest dimension is ≦300 μm. It is further advantageous to arrange different regions in the manner of a grid raster. In that way it is possible for the different objects which become visible with different angular positions of the polariser/the light source relative to the film element to appear seemingly in the same region.

The layers 23 and 22 are optional protective layers which can protect the security element from mechanical damage (for example abrasion). Furthermore this can involve layers which serve decorative purposes and lead to an enhanced status for the security feature. It would also be possible to dispense with that layer.

The replication layer 28 and the polymer layer 29 are like the replication layer 25 and the polymer layer 24, with the difference that the surface relief shaped into the replication layer 28 differs from that shaped into the replication layer 25 and thus the polymer layer 29 has regions 35 through 37 which differ from the regions 31 through 33 and in which the polymer layer 29 has differing linearly polarising or polarisation direction-rotating properties or no properties which alter the polarisation of the incident light. Thus for example the polarisation of the incident light is not altered in the region 37, while linear polarisation of the incident light occurs in the regions 35, corresponding to that in the regions 31 of the polymer layer 24 and in the regions 36 linear polarisation of the incident light in accordance with that in the regions 32 of the polymer layer 24.

The arrangement and extent of the regions 35 and 36 forms a second security feature which—as explained in relation to the layers 24 and 25—comprises one or more representations of one or more objects, that are altered upon rotation of the angular position of the film element 20 and the polariser/the light source relative to each other. That second security feature differs from the security feature afforded by the regions 31 and 32 for example in that different objects or a different number of objects are encoded by the regions 35 and 36, or 31 and 32 respectively, or the objects appear in a different angular position in respect of the film element 20 relative to the polariser/the light source, that is to say the linearly polarising or the polarisation direction-rotation properties of the regions differ. As also indicated in FIG. 3 the configuration of the regions 31, 32 and 33 and the regions 35, 36 and 37 and thus the local configuration of the linearly polarising or polarisation direction-rotating properties of the polymer layers 24 and 29 is completely independent of each other so that two completely different items of information are encoded in one and the same region of the film element 20 and—as explained hereinafter—can be rendered visible to the viewer in dependence on the viewing direction.

The adhesion layer 30 is preferably a thermally activatable adhesive layer which serves to apply the film 2 to the carrier element 10 of the security document 1. It is however also possible that the adhesion layer 30 is not provided in the region of the film element 20 or the adhesion layer 30 is a cold adhesive layer which is activatable by pressure.

In that respect production of the film element shown in FIG. 3a can be as follows:

A film with a polyester carrier and a layer stack formed from the layers 22, 23, 24, 25 and 26 is produced by the anisotropic polymer layer 26 firstly being applied to the polyester carrier. Subsequently as described above the replication layer 25 is applied and structured. The anisotropic polymer layer 24 is applied thereto. The further layers 22 or 23 are applied to the polymer layer 24.

The carrier with the layer stack is turned and provided on the rear side with the replication layer 28. That is structured as described hereinbefore and then provided with the anisotropic polymer layer 29. For use as a laminating or sticker film, an adhesive layer 30 is applied in order to fix the security element on the desired carrier element.

In addition it is also possible for the film element 20—besides the layers 22 through 30—also to have one or more further layers, in particular one or more further layers which afford a further, optically recognisable security feature.

Thus the security document has the following security features in the region of the transparent window 11:

When the security document 20 is viewed with unpolarised light in the incident light mode for example against a dark background, the viewing angle-dependent color shift effect generated by the polymer layer 26 is displayed, for example the film element 20 when viewing in an angle range of 30% around the surface normal appears red while it appears green when viewing outside that angle range. That is independent of whether the film element 20 is viewed from the front or rear side, that is to say the security document 1 is viewed from the front side or the rear side.

When the polymer layer 26 is of such a form that it comprises two layer portions of different cholesteric liquid crystal materials, that provides a different color impression, at the viewing side.

If the polymer layer 26 is of such a form that it comprises two or more different liquid crystal materials which are partially applied in two or more regions, a plurality of different color impressions—or items of colored image information as a first-line feature—can be integrated (see also FIG. 5).

When viewing in the transillumination mode by means of unpolarised light/without a polariser, the film element 20 appears as a transparent window both when viewing from the front side and also when viewing from the rear side, under some circumstances with a slight hint of color.

If the security document 1—as shown in FIG. 1—is viewed in the transillumination mode through the polariser 5, the representation 41 or 42 is displayed depending on the respective angular position as between the security document 1 and the polariser 5. The polariser 5 in this case is a simple linear polariser. In the FIG. 3a embodiment the regions 31 and 32 are arranged corresponding to the objects shown in the representations 41 and 42, that is to say the points appearing dark in the representation 41 are underlaid with regions 31 and the regions appearing light are underlaid with regions 32 so that, upon a change in the angular position between the polariser 45 and the security document 1 through 90°, the representation 42 is afforded. When viewing in the incident light mode through the linear polariser 5 (or when viewing in the incident light mode by means of a linearly polarised light source), that also gives the representations 41 and 42, with the difference that here the above-mentioned color shift effect additionally occurs.

When the security document 1 is viewed in the transillumination mode from the rear side—as shown in FIG. 2—a completely different optical impression is produced. In that case, at a first angular position of the security document 1 relative to the linear polariser 5, a representation 43 becomes visible for the human viewer while at an angular position which is rotated through 90° relative to that angular position, a representation 44 becomes visible. To represent the object shown in FIG. 2, in the embodiment of FIG. 3a regions 35 having first linearly polarising properties are provided in the polymer layer 29 in the regions shown dark in the representation 43 while the regions appearing gray in FIG. 2 involve regions 36 having linearly polarising properties differing therefrom. The polarisation axes of the linearly polarising regions 35 and 36 are thus rotated through 45° relative to each other in the FIG. 3a embodiment so that the FIG. 2 representations are produced upon rotation of the security document relative to the linear polariser 5 of 90°.

In the incident light mode viewing through the polariser 5 the representations 43 and 44 are also produced here, superposed with the above-described color change caused by the manner of implementing the polymer layer 26.

Surprisingly the similar polarisation effects generated by the polymer layers 24 and 29 are not mutually superposed in that way in the transillumination and incident light viewing mode and can be read out selectively in dependence on the viewing direction by means of a linear polariser. What is essential for that purpose is the arrangement of the polymer layer 26 having circularly polarising properties between the two polymer layers 24 and 29 having the linearly polarising/polarisation direction-rotating properties.

Investigations have shown in that respect that, instead of a cholesteric liquid crystal material, it is also possible to use a nematic liquid crystal material for the polymer layer 26, which has circularly polarising properties. It is also possible for the polymer layer 26 to have region-wise different circularly polarising properties, for example properties which have circular polarisation in right-handed relationship in a first region and properties which are circularly polarising in left-handed relationship in a second region, in which respect however it is necessary for the circularly polarising properties of the layer 26 to be present in all regions 31, 32, 35 and 36 in which the polymer layers 24 and 29 have linearly polarising/polarisation direction-rotating properties.

Further embodiments of the security element are described with reference to FIGS. 3b and 3c.

FIG. 3b shows the structure of a film element 20′ which is part of a sticker or laminating film. In this case all optically functional layers are on one side of the carrier material. The layers are produced as in the correspondingly referenced layers of the film element 20. Therefore the layer sequence is only briefly sketched out hereinafter:

Beginning with the carrier layer 27 the replication layer 25 is applied and structured as described hereinbefore. The anisotropic polymer of the polymer layer 29 is applied thereto. The anisotropic polymer layer 26 is applied to the polymer layer 29. That is followed by the replication layer 28 which is structured as described above. That is followed by the anisotropic polymer layer 24. Optionally further protective layers or layers having a decorative effect can follow. In the last step an adhesive layer is (optionally) applied. Depending on the respective requirements involved, that can be either at the rear side of the carrier layer 27 or it can be applied as the last layer to the layer stack 29-24. It is also possible for further printing or hologram layers for additional effects to be applied to the carrier layer 27 on the rear side.

An embodiment of the security element in the form of a hot or cold embossing film is shown in FIG. 3c. In a departure from the FIG. 3b structure, here there is an additional release layer 38 on the carrier layer 27, which is followed by the layer stack 24-29. In this case the adhesive layer 30 is in the form of a concluding layer, following the layer stack 24-29.

Besides the illustrated variants, further layer sequences are also possible. In that respect however what is decisive in terms of the function of the element is the respective arrangement of at least one anisotropic polymer layer on both sides of a central further anisotropic polymer layer.

A further embodiment of the invention is now described with reference to FIG. 4:

FIG. 4 shows a film element having a top side 61 and an underside 62. The film element 6 has a carrier layer 63, a replication lacquer layer 64, a polymer layer 65, an adhesion layer 66, a polymer layer 67, a replication layer 68, a carrier layer 69, an adhesion layer 70, a polymer layer 71, a replication layer 72 and a carrier layer 73.

The carrier layers 63, 69 and 73 are preferably polyester or polyolefin films of a thickness of between 5 μm and 50 μm. Structures for orientation of the liquid crystals of the polymer layer 65 are shaped in the replication layer 64 in regions 74 and 75, for example the linear grating described with reference to the replication layer 23. The polymer layer 65 is formed by a layer of a cholesteric liquid crystal material which is applied to the replication layer 64 by means of a printing process and then oriented in the regions 74 and 75 by the surface relief of the replication layer 64 and then fixed by crosslinking. In the regions 76 in which no surface relief is shaped in the replication layer 64 the polymer layer 65 does not have any properties influencing light polarisation.

In a preferred embodiment of the invention the polymer layer 65 is partially applied by printing to the replication layer only in the regions in which circularly polarising properties are to occur. Furthermore preferably different liquid crystal materials are applied by printing in different regions, thus for example a right-handedly circularly polarising liquid crystal material in the regions 74 and a left-handedly circularly polarising liquid crystal material in the regions 75.

Instead of cholesteric liquid crystal materials which in the oriented condition further also exhibit a color change it is also possible to apply by printing a nematic liquid crystal material or a plurality of nematic liquid crystal materials which upon suitable adjustment of the layer thickness have circularly polarising properties. A suitable configuration for the surface relief of the replication lacquer layer 64, for example superpositioning of the linear gratings in the regions 74 and 75 with a matt structure of a depth of between 200 nm and 800 nm and a correlation length in the micrometer range make it possible to achieve suitable adjustment of the circularly polarising properties of the liquid crystal material.

In regard to the detail configuration of the replication layer 64 and the polymer layer 65 attention is directed to the description relating to the layers 23, 24 and 26 shown in FIG. 3a. In addition it is also possible to dispense with the replication layer 64, to prepare the carrier layer 63 over the full surface area for the orientation of liquid crystal by mechanical scuffing or brushing and to apply liquid crystal material having circularly polarising properties to the carrier layer 63 in region-wise manner so as to afford a security feature for example in the form of a representation of an object on the basis of the shaping and arrangement of those regions.

The replication layer 72 and the polymer layer 71 are constructed like the replication layer 64 and the polymer layer 65, with the difference that the circularly polarising properties of the polymer layer 71 occur in regions 77 and 78 and not in regions 79 of the polymer layer 71 so that here a second security feature is afforded by the shaping and arrangement of the regions 77 and 78.

The polymer layer 67 is a layer comprising an oriented liquid crystal material which has linearly polarising properties in all of the regions 74, 75, 77 and 78.

As indicated in FIG. 4 it is possible in this case for the polymer layer 67 to have differing linearly polarising properties in region-wise manner, for example the polarisation axis in regions 81 and in regions 82 can be rotated relative to each other. In this case the polymer layer 67 is applied to the replication layer 68 in which a suitable surface relief is shaped for orientation of the polymer layer 67, in accordance with the foregoing description in respect of the layers 23 and 24 in FIG. 3a, oriented and then fixed.

To produce the film element 6 on the one hand the layers 64, 65 and 66 are successively applied to the carrier layer 63. The layer 68 and then the layer 67 are further applied to the carrier layer 69. Furthermore the layers 72, 71 and 70 are applied to the carrier layer 73. Then the laminating films produced in that way (in parallel) are placed one over the other in the sequence shown in FIG. 2 and joined together by activation of the adhesion layers 70 and 66.

When the film element 6 is viewed from the front side 61 in the transillumination mode through a circular polariser, the object represented by the regions 74 and 75 is displayed, with the object represented by the regions 77 and 78 remaining concealed. When the film element 6 is viewed from the rear side in the transillumination mode through a circular polariser (arranged between the film element 6 and the viewer), the object/objects defined by the regions 77 and 78 is or are displayed, while the object defined by the regions 74 and 75 remains concealed.

Similarly to the FIG. 3a embodiment, the use of differing circularly polarising regions makes it possible to encode a gray scale image in the layers 65 and 71 respectively, in which case for example dark regions of an object are backed by the regions 74, light regions of the object are backed by the regions 75 and light-gray regions of the object are backed by regions 76. An inverse representation of the object can be generated by using an oppositely circularly polarising polariser as a further security element. In addition the arrangement of different linearly polarising regions 81 and 82 makes it possible to encode a further security feature which can be read out by means of a linear polariser in the film element 6.

When viewing with unpolarised light the film element 6—as already explained in relation to the film element 20—appears as a transparent window, irrespective of whether the film element is viewed from the front side 61 or from the rear side 62.

A further embodiment of the invention will now be described with reference to FIG. 5. The structure corresponds to the layer sequence already described in relation to FIGS. 3b and 3c. In regard to the configuration of the individual layers attention is directed to the description relating to the correspondingly referenced layers in the embodiments of FIGS. 3a through 3c.

As shown in FIG. 5 the polymer layer 29 is subdivided into regions 34 and 35. In the regions 34 and 35 the layer 29 is formed by different anisotropic polymers. In this case two or more different cholesteric liquid crystal materials involving different color properties in the decoration are partially applied. By way of example a cholesteric liquid crystal material which presents a blue-green color change upon being tilted is applied in the regions 34 and a cholesteric liquid crystal material which presents a red-green color change upon being tilted is applied in the region 35. An additional first-line feature is generated by that special configuration of the central anisotropic layer 29. In that case different color impressions occur region-wise when the element is tilted, and can reproduce an item of image information if of a suitable configuration. That first-line feature is invisible in the transillumination mode.

1. A film element having a top side and an underside, wherein
the film element has a first polymer layer comprising an at least partially oriented liquid crystal material, wherein the first polymer layer has one or more first regions which form a first security feature and in which the polymer layer in a case a) has linearly polarising or polarisation direction-rotating properties or in a case b) has circularly polarising properties, the film element has a third polymer layer comprising an at least partially oriented liquid crystal material, wherein the third polymer layer has one or more third regions which form a second security feature and in which the polymer layer in the case a) has linearly polarising or polarisation direction-rotating properties or in the case b) circularly polarising properties, and the film element has a second polymer layer which is arranged between the first and third polymer layers and which in the regions arranged beneath the first regions and in the regions arranged above the third regions in the case a) has circularly polarising properties and in the case b) has linearly polarising or polarisation direction-rotating properties

2. A film element as set forth in claim 1, wherein the first and second regions overlap at least region-wise, wherein when viewing in the transillumination mode through a polariser or by means of polarised light depending on the respective viewing side the first or the second security feature is selectively visible to the human viewer in one and the same region.

3. A film element as set forth in, claim 1, wherein the film element comprises three or more transparent layers, wherein the first, second and third polymer layers respectively form one of the transparent layers and when viewing through a polariser or by means of polarised light in the transillumination mode the first or the second security feature is selectively visible to the human viewer in dependence on the viewing direction.

4. A film element as set forth in claim 3, wherein there is provided a polyester transparent carrier layer, as a further transparent layer.

5. A film element as set forth in claim 1, wherein, in the case a) the second polymer layer and in the case b) the first and/or the second polymer layer comprises a cholesteric liquid crystal material which when viewing in the incident light mode generates a viewing angle-dependent color shift effect as a further optically recognisable security feature.

6. A film element as set forth in claim 1, wherein in the case a) the second polymer layer comprises two or more different liquid crystal materials which are arranged layer-wise in mutually superposed or juxtaposed relationship.

7. A film element as set forth in claim 6, wherein the second polymer layer has two or more mutually juxtaposed regions in which the second polymer layer comprises different cholesteric liquid crystal materials which upon viewing in the incident light mode generate different viewing angle-dependent color shift effects as a further optically recognisable security feature.

8. A film element as set forth in claim 5, wherein the polymer layer comprising a cholesteric liquid crystal material or one of the polymer layers comprising a cholesteric liquid crystal material is provided region-wise in the film element to generate region-wise different color effects.

9. A security element as set forth in claim 1, wherein the first security feature includes an object with which first regions having varying polarisation properties are associated for generating a gray scale image.

10. A security element as set forth in claim 1, wherein the second security feature includes an object with which third regions having varying polarisation properties are associated for generating a gray scale image.

11. A film element as set forth in claim 1, wherein the first security feature and/or the second security feature includes two or more first objects with which in the case a) first regions or third regions respectively having different linearly polarising or polarisation direction-rotating properties are associated and in the case b) first regions or third regions respectively having different circularly polarising properties are associated.

12. A film element as set forth in claim 1, wherein the first and/or third regions are of a respective extent of less than 300 μm and the polarisation properties of at least two of the first regions and/or two of the third regions differ.

13. A film element as set forth in claim 1, wherein the film element has at least one replication layer to which the first or the third polymer layer comprising a liquid crystal material is applied, and wherein a diffractive structure for orientation of the polymer layer comprising a liquid crystal material is introduced into the surface of the replication layer, that is towards the polymer layer comprising a liquid crystal material, in the first and third regions respectively.

14. A film element as set forth in claim 13 wherein the diffractive structure is a line grating with a spatial frequency of between 1500 lines/mm and 3500 lines/mm and of a depth of between 50 nm and 500 nm.

15. A film element as set forth in claim 14, wherein the line grating has region-wise a different azimuth orientation.

16. A film element as set forth in claim 1, wherein the film element has a further layer with an optically effective structure which affords a further optically recognisable security feature.

17. A film element as set forth in claim 16 wherein the further optically effective structure is superposed in relation to the first and third regions at least region-wise.

18. A film element as set forth in claim 1, wherein the film element has a thin film layer system for producing a color shift by means of interference, which affords a further optically recognisable security feature.

19. A film element as set forth in claim 18, wherein characterised in that the thin film layer system is superposed in relation to the first and second regions at least region-wise.

20. A film element as set forth in claim 1, wherein the film element is part of a film forming an optical security element for safeguarding value-bearing documents.

21. A film element as set forth in claim 20, wherein the film is shaped in the form of a security thread.

22. A security document having a film element as set forth in claim 1.

23. A security document as set forth in claim 22, wherein the film element is arranged in a transparent window of the security document.

24. A security document as set forth in claim 22, wherein the security document further has a polarizer which can be brought into overlapping relationship with the film element by folding or bending f the security document.
